(19) United States
(12) Patent Application Publication
(10) Pub. No.: US 2012/0015204 A1
(43) Pub. Date: Jan. 19, 2012

(54) STAINLESS STEEL ALLOY

(75) Inventors: Timothy J. McCabe, Wilsonville, OR (US); Chandramouleeswaran Vaidyanathan, Wilsonville, OR (US)

(73) Assignee: Climax Molybdenum Company, Phoenix, AZ (US)

(21) Appl. No.: 13/184,714

(22) Filed: Jul. 18, 2011

Related U.S. Application Data
(60) Provisional application No. 61/365,657, filed on Jul. 19, 2010.

(51) Int. Cl. B32B 3/24; B22F 3/12; B32B 15/00; B05D 7/00; B22F 3/15; B22F 3/24; C22C 38/00; B22F 1/00

(52) U.S. Cl. 428/546; 420/8; 419/23; 75/255; 427/216

(57) ABSTRACT

Stainless steel alloy composition. The stainless steel alloy composition includes rounded carbides and free chromium in a ferrite matrix. The rounded carbides have particle sizes under 5 microns. The rounded carbides include a first quantity of niobium-containing carbide and a second quantity of chromium carbide, and are substantially free of large, irregularly-shaped carbides.

### CROSS-REFERENCE TO RELATED APPLICATION

Applicants claim priority under 35 U.S.C. §119(e) to provisional patent application No. 61/365,657, which is incorporated herein by reference for all that it teaches.

### FIELD OF THE INVENTION

This invention relates generally to stainless steel alloy compositions and methods for making them, and more specifically to stainless steel alloy net shape parts and near net shape parts and methods for making them.

### BACKGROUND OF THE INVENTION

Stainless steel alloys are well-known and are widely prized for their strength and corrosion resistance. There are many grades and types of stainless steel, the properties of which vary based on their constituents and the manner in which they are made. Standard grades 420 and 440C stainless steel may be used for metal injection molded (MIM) parts and MIM parts subjected to secondary machining, although 440C stainless steel is harder than 420 stainless steel.

### BRIEF SUMMARY OF THE INVENTION

An embodiment of a stainless steel alloy composition of the present invention, comprises: rounded carbides in a matrix comprising at least one selected from the group consisting of ferrite and martensite, the rounded carbides having particle sizes under 5 microns, comprising a first quantity of niobium-containing carbide and a second quantity of chromium carbide, and being substantially free of large, irregularly-shaped carbides; and free chromium in the ferrite matrix.

In another embodiment, the present invention comprises a net shape part material, consisting of a densified alloy of precursor powders, the precursor powders being of a size no greater than −325 U.S. Tyler mesh and comprising metal powders of at least carbon, chromium, niobium and iron, the carbon being in a first amount, the niobium being in a second amount that is greater than the first amount, and the chromium being in a third amount that is greater than the second amount.

Yet another embodiment of the invention comprises a method for making a stainless steel alloy net shape part, comprising: providing a supply of metal powders comprising at least, carbon, niobium, chromium and iron, the metal powders having an average particle size of less than about 25 microns; removing oversized particles from the supply of metal powders to form a supply of sized metal powders consisting essentially of particles no greater than 44 microns in size with less than about 0.5 weight percent of the particles having a size between greater than about 44 microns and about 100 microns; providing a supply of binder; compounding the supply of sized metal powders with the supply of binder to form a feedstock; injecting the feedstock into a near net shape mold, making a green part; ejecting the green part from the near net shape mold; debinding the green part, making a brown part; subjecting the brown part to thermal cycling at a temperature between about 816° C. and about 1093° C.; sintering the brown part in the furnace at a temperature between about 1246° C. and about 1343° C., making a sintered part; performing hot isostatic pressing on the sintered part at a temperature between about 899° C. and about 1121° C., making the stainless steel alloy net shape part; and cooling the stainless steel alloy net shape part at a rate of between about 1° C. per minute to about 7° C. per minute.

In another embodiment, a feedstock for molded metal parts, comprises: metal powders, the metal powders comprising at least carbon, niobium, chromium and iron, the metal powders consisting of particles no greater than −325 mesh in size and having an average particle size of less than about 25 microns; and binder in combination with the metal powders to make the feedstock consisting of about 6.5 wt. % to about 8 wt. % binder and a remaining weight percent of the metal powders, the weight percent of the metal powders and the weight percent of the binder totaling 100 wt. %.

In still other embodiments, a method for making a feedstock for molded metal parts, comprises: providing a supply of metal powders comprising at least, carbon, niobium, chromium and iron, the metal powders having an average particle size of less than about 25 microns; passing particles from the supply of metal powders through a screen no larger than 325 U.S. Tyler mesh to form a supply of sized metal powders; providing a supply of binder; compounding the supply of sized metal powders with the supply of binder to form the feedstock, the feedstock consisting of binder in a range of between about 6.5 wt. % to about 8 wt. % and metal powders in a remaining weight percent of the metal powders.

### BRIEF DESCRIPTION OF THE DRAWINGS

Illustrative and presently preferred exemplary embodiments of the invention are shown in the drawings in which:

FIG. 1 is a micrograph of 440C stainless steel with large carbides;

FIG. 2 is a micrograph of the stainless steel alloy composition of the present invention;

FIG. 3 is a micrograph of the stainless steel alloy composition comprising 0.4% carbon;

FIG. 4 is a micrograph of the stainless steel alloy composition comprising 0.6% carbon;

FIG. 5 is a micrograph of the stainless steel alloy composition comprising 0.8% carbon;

FIG. 6 is a micrograph of the stainless steel alloy composition comprising 0.87% carbon;

FIG. 7 is a micrograph of the stainless steel alloy composition comprising 1.04% carbon;

FIG. 8 is a micrograph of the stainless steel alloy composition comprising 1.17% carbon;

FIG. 9 illustrates an embodiment of a method for making feedstock according to the present invention;

FIG. 10 illustrates an embodiment of a method for making feedstock according to the present invention using apparatus;

FIG. 11 illustrates an embodiment of a method for making a net shape part according to the present invention;

FIG. 12 illustrates an embodiment of a method for making a net shape part according to the present invention using continuous furnace apparatus;

FIGS. 13A-13C illustrate test results from wear resistance testing performed on an embodiment of the stainless steel alloy composition of the present invention; and

FIGS. 14A-14C illustrate test results from wear resistance testing performed on an embodiment of the stainless steel alloy composition of the present invention.

### DETAILED DESCRIPTION OF THE INVENTION

The present invention comprises stainless steel alloy composition 10, as well as method 100 for making it. In addition, the present invention also comprises a novel feedstock 20, as well as method 200 for making feedstock 20. In embodiments of the present invention, feedstock 20 may be used in performing method 100 to produce stainless steel alloy composition 10 and novel stainless steel alloy net shape part 34. For purposes of the present invention, “net shape part” means a geometrically complex metal part, often multidimensional, produced through metal injection molding (MIM) processes in which mold 22, as well as green part 24 produced in mold 22, are larger than final stainless steel alloy net shape part 34, as will be explained in more detail below. As used herein, “net shape part” also includes near net shape parts that may be subject to additional processing after MIM.

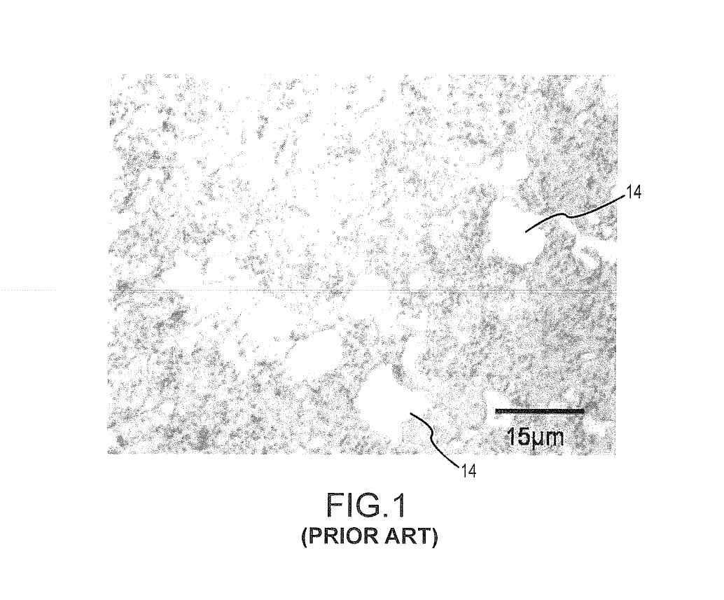

Stainless steel alloy composition 10 of the present invention will now be described in greater detail. Using feedstock 20 that comprises supply of metal powders 16 and binder 18, the stainless steel alloy composition 10 of the present invention was developed to provide material properties conducive and favorable to metal cold working and secondary machining of final stainless steel alloy net shape part 34 produced by embodiments of method 100, 300, while also achieving good wear and corrosion resistance. Whereas 440C stainless steel has desirable wear characteristics, it lacks suitable secondary formability and corrosion resistance characteristics. 440C stainless steel may be characterized by its large (e.g., about 10 microns or greater in size), blocky or irregularly shaped carbides 14, as shown in FIG. 1. During deformation processes, such as secondary machining, the irregularly-shaped large carbides 14 may interact with each other, hindering the movement of the material. While the material matrix may yield during cold working and machining, the large, irregularly-shaped carbides 14 would not, making it very difficult to cold work the 440C stainless steel material or otherwise subject it to secondary machining (e.g., stamping, slotting, piercing, drilling, tapping, pressing, sizing, embossing, reaming, forging, fine blanking, and the like). The relatively higher carbon content of 440C stainless steel may make it more susceptible to corrosion. On the other hand, while 420 stainless steel can be cold worked and machined with good corrosion resistance, it does not exhibit wear characteristics as favorable as those of 440C stainless steel. Thus, for industrial applications, in particular, a need has been identified to develop a novel type of stainless steel alloy in a net shape part to exhibit excellent wear resistance and corrosion resistance, along with deformation characteristics favorable for secondary machining with geometric and dimensional precision. Stainless steel alloy composition 10 of the present invention fills that need, allowing formation of net shape part 34 that may be readily deformed with precision during secondary machining, as is described in more detail below.

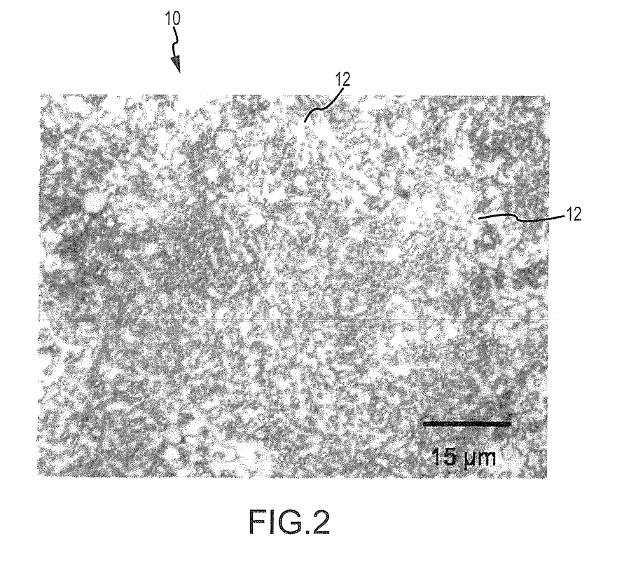

Stainless steel alloy composition 10, formed from feedstock 20, as will be described in more detail below, comprises at least carbon, chromium, niobium and iron. Stainless steel alloy composition 10 may be considered a martensitic stainless steel comprising ferrites or martensites or both, and carbides. Carbides included in the present invention comprise both niobium-containing carbides, as well as chromium carbides, although the quantity of niobium-containing carbides exceeds the quantity of chromium carbides. Niobium-containing carbides include both niobium carbides, as well as complex carbides, as is explained in more detail below. Carbide formation is believed to be enhanced in the present invention by the presence of niobium which reacts well with the carbon to form relatively stable niobium-containing carbides with good tempering resistance, enhanced temperature stability and increased hardness. It is believed that the higher temper temperature stability of the niobium-containing carbides may allow for their formation at higher temperatures, thereby providing carbide nucleation sites, resulting in an increased number of niobium-containing carbides. The carbides of the present invention may be described as small carbides 12 that are rounded carbides with a substantially uniform, small grain size of less than 5 microns. FIG. 2. It is believed that the presence of niobium in embodiments of the present invention may help to maintain the rounded shape of the small carbides 12. The rounded carbides are substantially uniformly dispersed in the final material matrix of the stainless steel alloy composition 10, comprising ferrite or martensite or both, with relatively small ferrite/martensite distances between the carbides. In contrast, FIG. 2, for example, shows relatively large ferrite distances between carbides. The shape of these rounded carbides may be described as more smooth and more spherical than blockier shaped large carbides 14 of known stainless steel alloys (e.g., 440C stainless). Compare FIG. 1 with FIG. 2.

In addition, it is also believed that niobium addition improves corrosion resistance in the present invention, given that corrosion resistance decreases with increasing carbon levels. With the niobium forming carbides in the present invention, some chromium does not form carbides and remains free in the final matrix, leaving the free chromium available for corrosion protection which may enhance the corrosion resistance of the stainless steel composition 10 of the present invention compared to known stainless steel compositions.

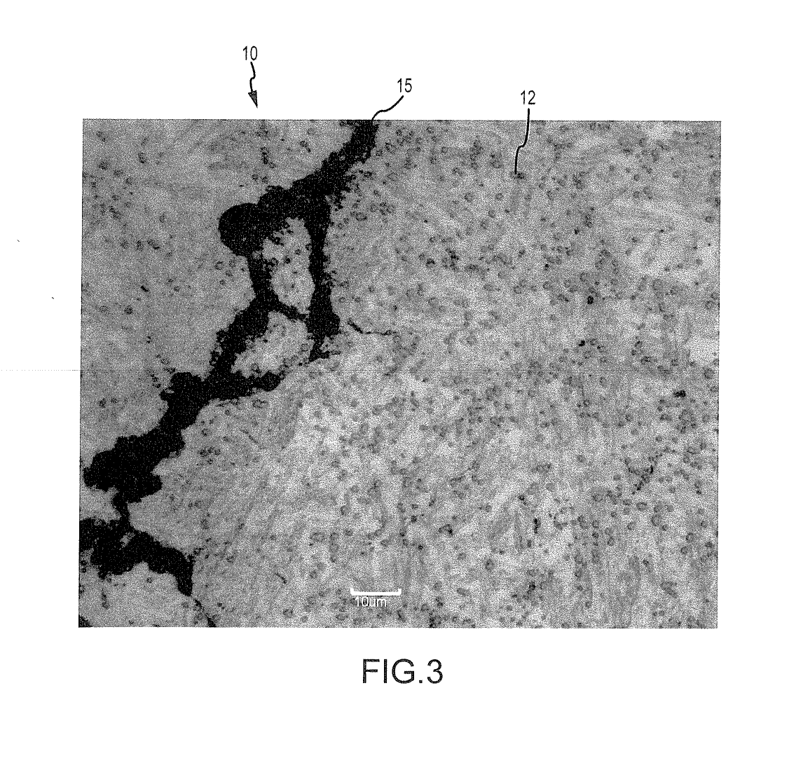

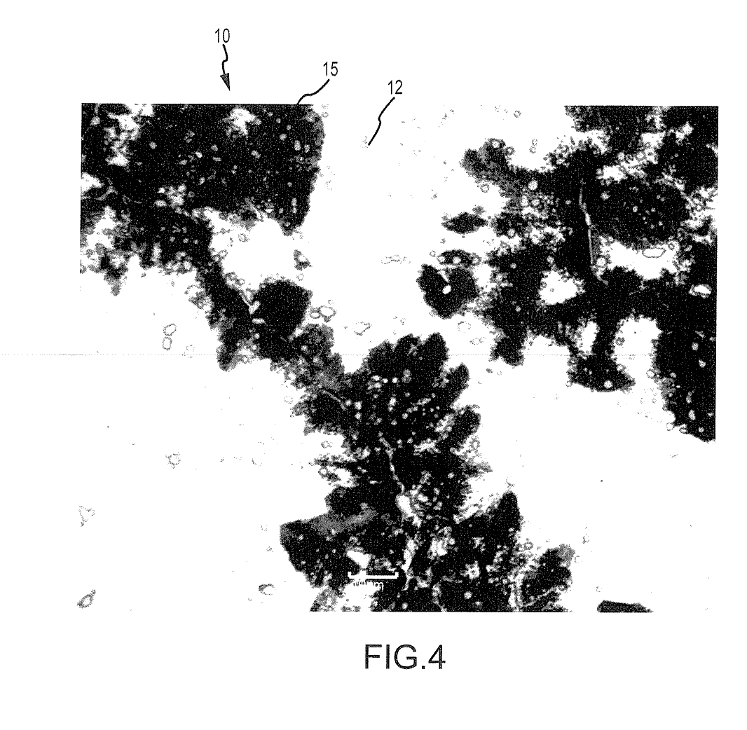

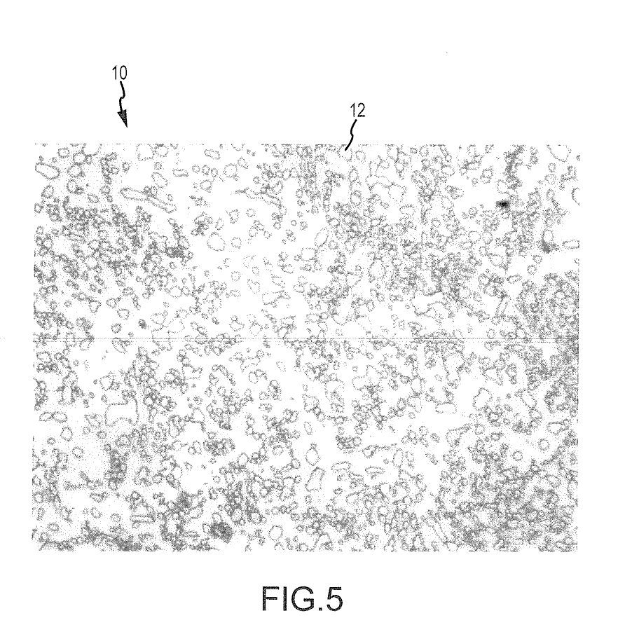

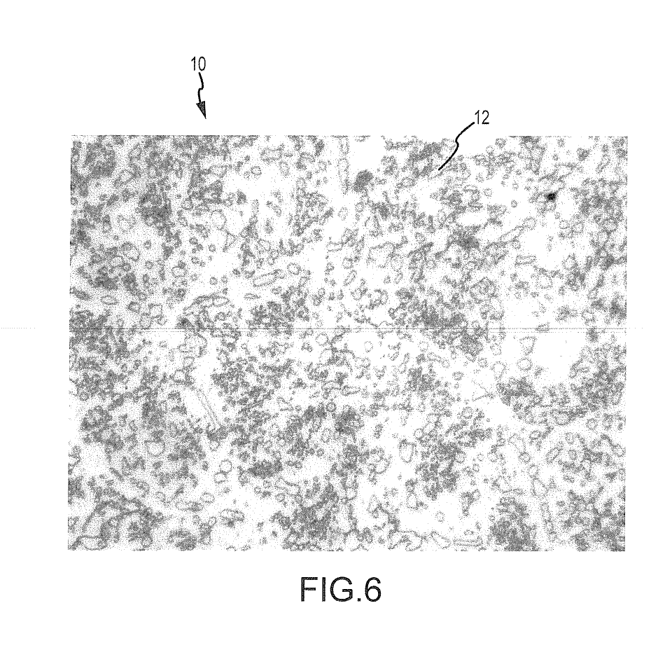

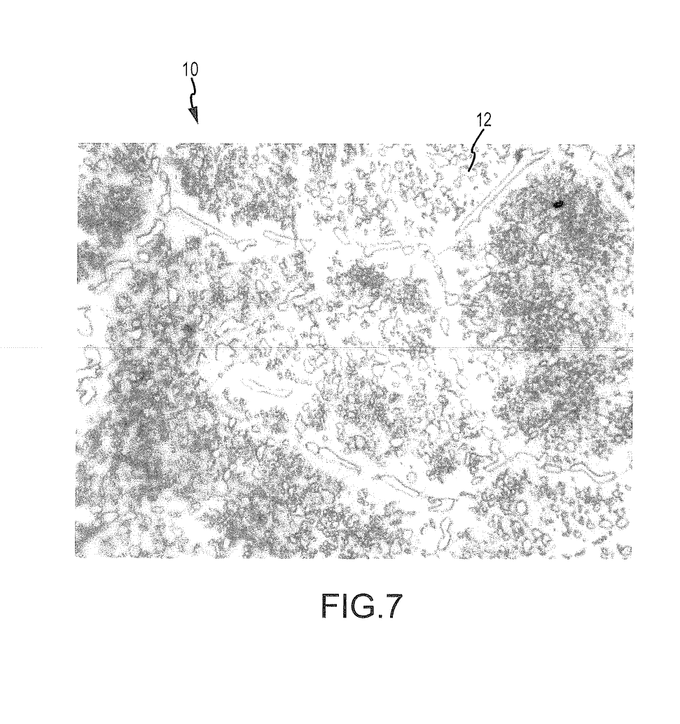

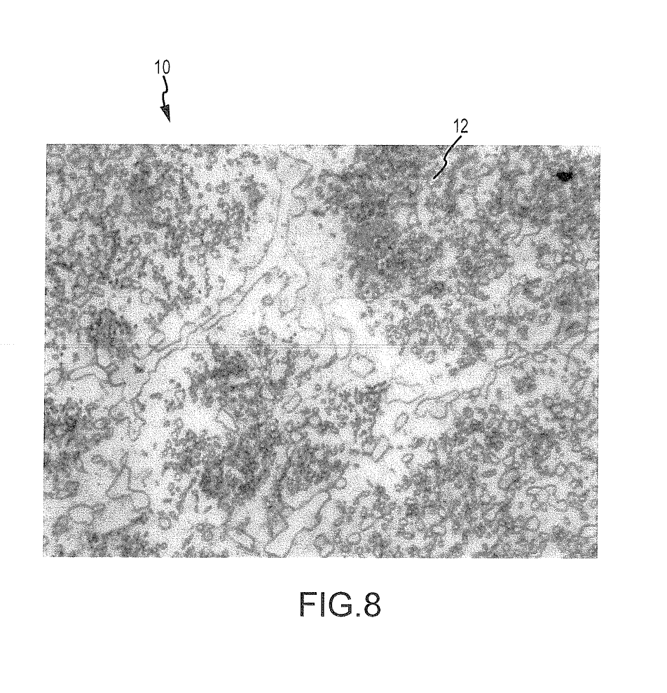

Carbide formation in stainless steel alloy composition 10 is also influenced by carbon content; physical properties of the stainless steel alloy composition 10 may vary with carbon content. The stainless steel alloy composition 10 achieves a beneficial balance between carbon, niobium, chromium and other constituents through carbide formation, it is believed, given that higher carbon content increases wear resistance, but decreases corrosion resistance and formability, while on the other hand, lower carbon content enhances formability while sacrificing corrosion and wear resistance properties. In addition, higher carbon content may enhance carbide formation on grain boundaries, which may reduce toughness at the grain boundaries. FIGS. 3-8 illustrate microstructure of stainless steel alloy composition 10, including small carbides 12, with amounts of carbon ranging from about 0.4% to about 1.17% carbon in the final stainless steel alloy composition 10 subjected to hot isostatic pressing (“HIP'ing”), as described above, which description is incorporated herein. As shown in FIGS. 3 and 4, dark area 15 appears at some grain boundaries. This is believed to occur from slower cooling rates that cause these areas to etch more darkly and appear as dark area 15.

As mentioned above, the stainless steel alloy composition 10 of the present invention comprises at least carbon, chromium, niobium and iron. Further, stainless steel alloy composition 10 of the present invention comprises rounded carbides in the matrix of ferrite, martensite or both, the rounded carbides having particle sizes under 5 microns. The rounded carbides comprise niobium-containing carbides and chromium carbides. The niobium-containing carbides may comprise complex carbides, NbC, Nb₂C, Nb₄C₃ or any combination thereof. The complex carbide may comprise M₂₃C₆ wherein “M” represents niobium plus any other metal or combination of metals such as chromium, molybdenum or other metals as would be familiar to one of ordinary skill in the art after becoming familiar with the teachings of the present invention. The chromium carbide may comprise Cr₂₃C₆, CrC₃, Cr₇C₃, Cr₃C₂ or any combination thereof. The percentage of carbides in the microstructure of the stainless steel alloy composition 10 of the present invention comprises from about 4 to about 25 weight percent, including a first quantity of niobium-containing carbide and a second quantity of chromium carbide, wherein the first quantity exceeds the second quantity. The microstructure of the stainless steel alloy composition 10 of the present invention is substantially free of irregularly-shaped large carbides 14 of the type shown in FIG. 1. Moreover, since more of the niobium tends to form carbides than chromium, free chromium is left in the final matrix, enhancing corrosion resistance.

Thus, the stainless steel alloy composition 10 allows for production of net shape part 34 made according to embodiments of method 100 of the present invention. Net shape part 34 comprises a solid, molded structure formed from stainless steel alloy 10 as described herein. “Solid” as used herein in connection with near net shape part 34 means material substantially free from pores and voids, with the few pores and voids that remain after sintering and/or HIP'ing or other additional heat treating being generally smaller than 5 microns. In addition, the solid, molded structure of near net shape part 34 has a surface that is substantially smooth, meaning that it is substantially free from pits, voids, cracks and other similar defects.

In embodiments of the invention, stainless steel alloy composition 10 forming the material of net shape part 34 may comprise a densified alloy of the metal and non-metal powders used to make net shape part 34, such as supply of metal powders 16. As is explained in more detail below, densification of the alloy may be achieved following sintering 312 alone or sintering 312 and/or HIP'ing and additional heat treatment, depending on the desired material density and the secondary processes to which net shape part 34 may be subjected.

The supply of metal powders 16 used to make the densified alloy of the present invention may comprise combinations of predominantly metal powders that have been premixed, and that may or may not include small amounts of other metals and non-metals. In other embodiments, the supply of metal powders 16 may comprise elemental powders of the desired metals and non-metals. No matter what form the supply of metal powders 16 may take, the composition of the supply of metal powders 16 has been analyzed by element. Thus, the supply of metal powders 16 of the present invention may comprise the following elements: Starting amounts for carbon may be in a range of about 0.733 to about 1.349 weight percent (wt. %), with 0.5 to 1.0 wt % preferred in some embodiments, depending on the characteristics desired in the final material. In other embodiments, carbon in a range of 0.4 to 0.85 wt. % may be preferred. Chromium may be included in a range of about 12.790 to about 19.456 wt %, although it can be as low as 10.0 wt. %, with about 11.0 to about 16.0 wt. % preferred in some embodiments. In other embodiments, about 11.0 to about 15.5 wt % or 11.0 to about 17.0 wt. % of chromium may be preferred. Niobium may be included in a range of about 1.175 to about 2.964 wt. %, although it can be as low as about 1.0 wt. %, with about 1.0 to about 3.0 wt. % preferred in some embodiments, and about 1.0 to 2.0% preferred in other embodiments. Iron may be present in a range of about 75.895 wt. % to about 85.626 wt. %. Iron may also be measured as the balance of remaining material, once the weight percents of all the other metals, including the optional elements described below, have been determined.

In other embodiments, it may be said that the amount of niobium in the supply of metal powders 16 may be in a range of between about 1 to about 8 times greater than the amount of carbon; in other embodiments, niobium amounts may be between about 1.01 and 3.46 times greater than carbon amounts. In some embodiments, the amount of chromium in the supply of metal powders 16 may be in a range of between about 11 to 38.75 times greater than the amount of carbon; in other embodiments, chromium amounts may be between about 8.94 to about 17.85 times greater than carbon amounts. In embodiments, the amount of chromium in the supply of metal powders 16 may be said to be in a range of between about 3.67 and about 16 times greater than the amount of niobium; in other embodiments, chromium amounts may be between about 4.67 and about 10.89 times greater than niobium amounts.

The stainless steel alloy composition 10 may also comprise other elements, but these are not required. The other metals and non-metals include manganese, silicon, sulfur, copper, nickel, oxygen, molybdenum and phosphorous. In various embodiments of the present invention, manganese may be present in the supply of metal powders 16 used for the feedstock 20 in a range of about 0.066 to about 0.248 wt. % up to a maximum of about 1.0 wt. %; silicon, in a range of about 0.154 to about 0.862 wt. % up to a maximum of about 1.0 wt. %; sulfur, in a range of about 0.004 to about 0.025 wt. % up to a maximum of about 0.03 wt. %; copper with a maximum of about 0.3 wt. % to about 0.5% being preferred; nickel, in a range of about 0.000 to about 0.624 wt. %, but preferably not more than 0.6 wt. % maximum; oxygen, in a range from about 0.267 to about 0.636; phosphorous in a range from about 0.012 wt. % to about 0.034 wt. % with a maximum of 0.045 wt. %; and molybdenum up to a maximum of 1.0 wt. %.

The stainless steel alloy composition may also comprise small amounts of other elements up to a maximum of about 1.0 wt. % combined, as measured in the processed material.

During the various heating processes to which the feedstock 20 is subjected after being injected into molds (which are discussed in more detail below), some non-metallic elements, such as oxygen and free carbon (not in carbide form) may be lost. Loss experienced is generally slightly greater than about 0.2 wt. %. Carbon loss may be influence by the amount of oxygen present, with larger amounts of oxygen resulting in higher loss and smaller amounts of oxygen resulting in lower carbon loss. Thus, amounts of carbon in the final stainless steel alloy composition 10 may be in a range from about 0.4 wt. % to about 1.17 wt. % carbon in the final stainless steel alloy composition 10.

Embodiments of method 100 for making the stainless steel alloy composition will now be described. Method 100 comprises method 200 for making feedstock 20 and method 300 for making net shape part 34.

Method 200 comprises embodiments for making feedstock 20 that comprises about 92 to about 93.5 wt. % of sized metal powders 17, with binder 18 comprising about 6.5 to about 8 wt. %, preferably from about 6.77 to about 7.7 wt. %. In other embodiments, feedstock 20 consists essentially of about 6.5 wt. % to about 8 wt. %, preferably from about 6.77 to about 7.7 wt. %, binder 18 with the balance of the feedstock 20 being sized metal powders 17.

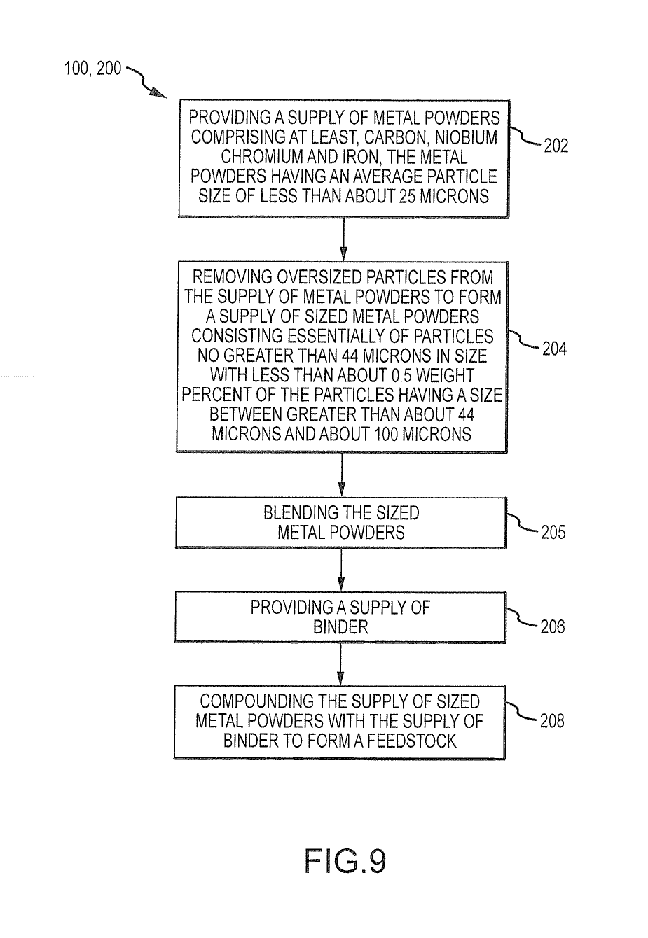

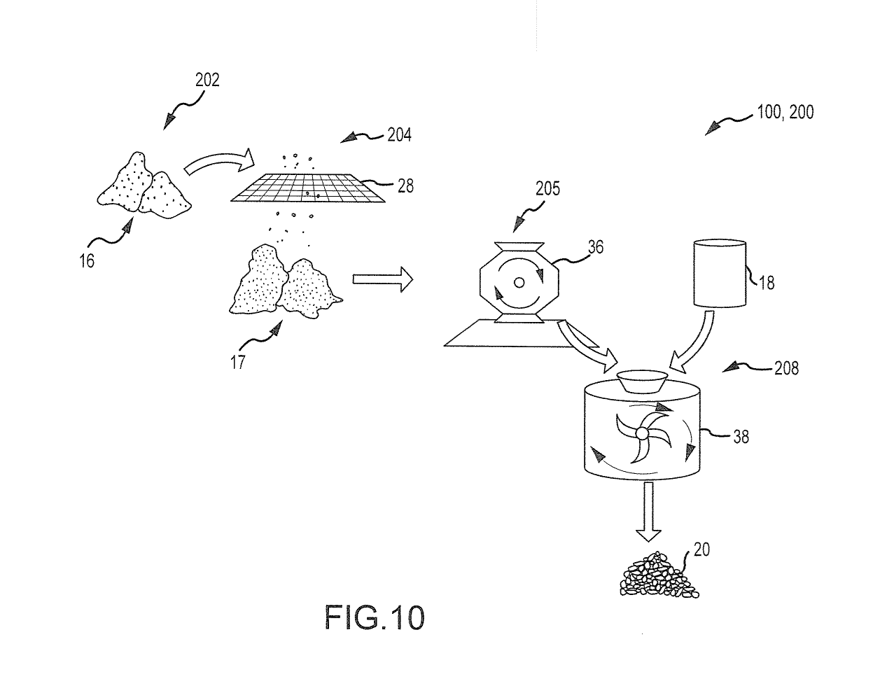

Method 200 for making feedstock 20 will now be discussed with reference to FIGS. 9 and 10. Method 200 comprises providing 202 supply of metal powders 16; removing 204 oversized particles from the supply of metal powders 16 to make sized metal powders 17; blending 205 the metal powders; providing 206 supply of binder 18; and compounding 208 the sized metal powders 17 with the supply of binder to form feedstock 20.

Providing 202 the supply of metal powders 16 according to an embodiment of method 200 comprises providing 202 the supply of metal powders 16 comprising at least carbon, niobium, chromium and iron. In various embodiments of the method, the supply of metal powders 16 comprises combinations of 420 powder plus niobium or 440C powder plus niobium, carbonyl iron powder (CIP), ferrochrome powder, high carbon ferrochrome powder and precipitation hardening martensitic stainless steel powder with copper and niobium additions, as are described in more detail below. The 420 powder (MHT420J2NB) and 440C (MHT440CNB) powder are commercially available from Mitsubishi Steel Mfg. Co. Ltd. of Tokyo, Japan. The CIP powder (S-1641) comprises iron and 0.7 wt. % SiO₂ as a milling agent and is commercially available from International Specialty Products of Wayne, N.J. The ferrochrome powder is 70/30 FeCr powder commercially available from Ametek Specialty Metal Products of Eighty Four, Pa. High carbon ferrochrome powder comprising the supply of metal powders 16 is commercially available from F.W. Winter Inc. & Co. of Camden, N.J. The precipitation hardening stainless steel powder is a 17-4PH powder comprising about 17 wt. % chromium, 4 wt. % nickel and 4 wt. % copper, with about 0.3 wt. % niobium and is commercially available from a variety of sources, including Ametek Specialty Metal Products.

The metal powders are combined in accordance with the teachings of the present invention to achieve the weight percents of the various elements as have been previously discussed and that are discussed in the specific examples below. Thus, although the stainless steel composition 10 and the method 200 of the present invention are discussed in terms of combinations of stainless steel type metal powders, elemental powders could also be used for supply of metal powders 16 as would be familiar to one of ordinary skill in the art after becoming familiar with the teachings of the present invention.

The starting powders for the supply of metal powders 16 comprise particles of less than about 297 microns (e.g., about −50 U.S. Tyler mesh) in size with an average particle size in a range of about 3 to about 25 microns, with about 3 to about 10 microns preferred. High carbon ferrochrome powder is toll ground into a fine powder of less than about 25 microns, with an average particle size of about 3 to about 10 microns preferred. Various of these metal powders are admixed or blended 205 together (e.g., using mixer 36) to form the supply of metal powders 16 of average particle size of less than about 25 microns (about 3 to about 10 microns preferred).

Regardless of the average particle size, outsized particles may be present or agglomerations may form in the metal powders under variety of circumstances. Thus, method 200 further comprises removing 204 oversized particles from the supply of metal powders 16 to produce a supply of sized metal powders 17. It is believed that oversized particles, including oversized carbon metal powder particles, may cause localized melting leading to surface pits, or other flaws or surface imperfections in net shape part 34. Removing 204 oversized particles may comprise separating, milling, grinding, crushing or other similar processes to remove oversized particles from the supply of metal powders 16 to produce sized metal powders 17. In one embodiment of method 200, removing 204 comprises screening using screen 28, for example, as shown in FIG. 10. The size of screen 28 used for the screening process may be selected to ensure that the sized metal powders 17 consist essentially of particles that are no greater than 44 microns in size, with no more than about 0.5 weight percent of particles in supply of metal powders 16 being between greater than about 44 microns and 100 microns. In embodiments of method 200, the screen 28 size used was −325 U.S. Tyler mesh. In other words, the particles of the sized metal powders 17 all passed through the 325 U.S. Tyler mesh screen, meaning that substantially all of the particles were 44 microns or less in size, with some particles being larger. For example, particles that are not substantially round and are long and narrow with less than 44 microns in the smallest dimension may nonetheless pass through the 325 screen although their overall particle size would be larger than 44 microns. Of course, finer screen sizes could also be used as would be apparent to one of ordinary skill in the art after becoming familiar with the teachings of the present invention.

In one embodiment, the metal powders were screened in the manner previously described to remove 204 oversized particles to produce sized metal powders 17 before blending 205 of the metal powders. Thus, in another embodiment, removing 204 oversized particles from the supply of metal powders 16 may comprise screening the carbon containing metal powders to a size of less than about 44 microns (e.g., −325 U.S. Tyler mesh), while otherwise ensuring that the other metal powders are 100 microns or less in particle size.

However, in another embodiment, the removing 204 (e.g., screening) step may occur after the metal powders have been initially blended 205. So long as the removal 204 step is performed prior to compounding 208, the desired results may be achieved.

With respect to one embodiment, it was determined that having particles sizes no greater than 44 microns in the sized metal powders 17 (e.g., the metal powders were passed through the 325 U.S. Tyler mesh screen) is a result dependent variable for producing net shape part 34 with a molded structure that is solid with a substantially smooth surface. In another embodiment, having carbon metal powder particle sizes of no greater than 44 microns, while the other metal powder particle sizes were 100 microns or less, would be a result dependent variable for producing net shape part 34 with a solid molded structure having a substantially smooth surface.

Method 200 further comprises providing 206 a supply of binder 18. The binder 18 used in feedstock 20 comprises a thermoplastic polymer/wax system binder that is widely commercially available. Other binders 18 that are known in the art could also be used as would be familiar to one of ordinary skill in the art after becoming familiar with the teachings of the present invention.

In an embodiment of method 200, next the supply of sized metal powders and the supply of binder 18 are compounded 208. The compounding 208 step of method 200 of the present invention comprises combining the supply of sized metal powders 17 with the supply of binder 18 to produce feedstock 20 using conventional techniques and equipment for compounding metal powders and binder for metal injection molding processes (e.g., using compounding mixer 38). While typical MIM processes of the prior art use around 60 volumetric percent metal powder and 40 volumetric percent binder, in methods 100, 200, 300 of the present invention the supply of sized metal powders 17 comprises about 92 to about 93.5 wt. % of the feedstock 20 with the binder 18 comprising about 6.5 to about 8 wt. %, preferably from about 6.77 to about 7.7 wt. %, with the balance being sized metal powders 17. Following the compounding 208 step, the feedstock 20 is substantially homogeneous. As described above, the stainless steel alloy composition 10 of the present invention comprises small rounded carbides 12 of small grain size and a generally spherical type. It is believed that this particle morphology of the present invention allows for a substantial reduction in the amount of binder 18 used over prior art compositions and methods.

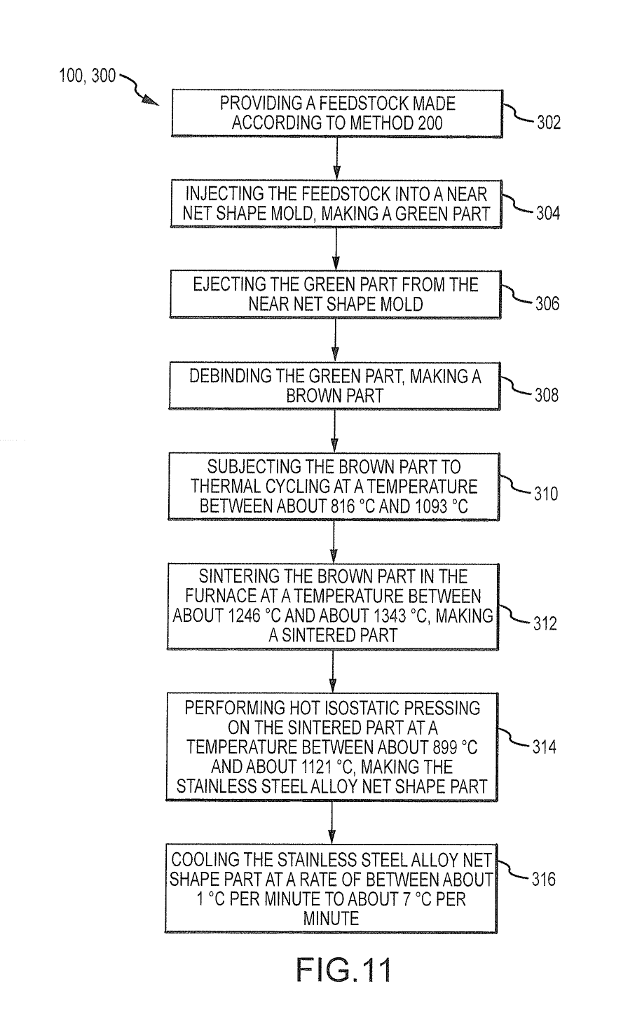

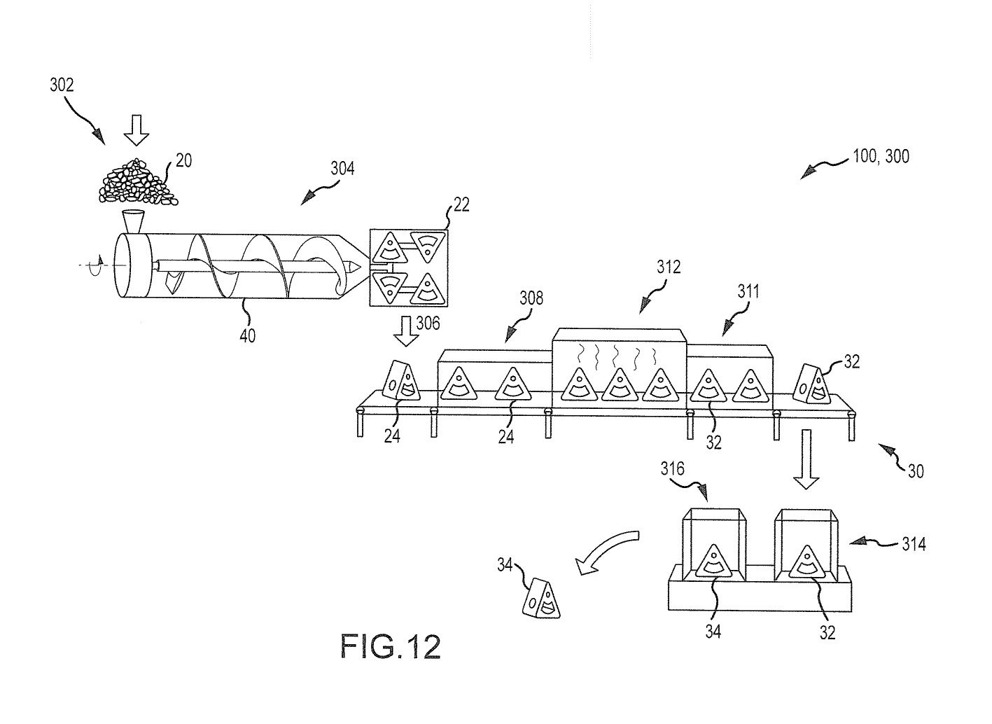

Method 300 for making net shape part 34 will now be discussed with reference to FIGS. 11 and 12. Method 300 comprises providing 302 feedstock 20 made according to embodiments of method 200; injecting 304 feedstock 20 into near net shape part mold 22, making green part 24; ejecting the green part from the near net shape mold; debinding 308 green part, making brown part 26; subjecting 310 brown part 26 to thermal cycling; sintering 312 brown part 26 in furnace 30, making sintered part 32; performing 314 hot isostatic pressing on sintered part 32, making the stainless steel alloy net shape part 34; and cooling 316 stainless steel alloy net shape part 34.

As described above, method 300 comprises providing 302 feedstock 20 made according to embodiments of method 200. Method 300 may further comprise heating the feedstock 20 and injecting 304 feedstock 20 into near net shape part mold 22 for the desired MIM near net-shape part 34 to form green part 24, which is then ejected 306 (e.g., removed) from near net shape part mold 22. Near net shape part mold 22 may be generally around 20% larger in volume that the final near net shape part 34 to account for shrinkage that occurs primarily during sintering 312.

Method 300 further comprises debinding 308 green part 24 to remove a substantial amount of binder. In an embodiment of the present invention, method 300 comprises using thermal debinding techniques to remove substantial quantities of binder from green part 24, thereby producing brown part 26. Debinding processes are well known. The remaining binder is removed during other heating processes, including sintering 312. Chemical, catalytic and other debinding processes may also be used as would be appropriate for the type of binder used as one of ordinary skill in the art would know after becoming familiar with the teachings of the present invention.

Method 300 of the present invention may further comprise subjecting 310 the brown part 26 to thermal cycling immediately prior to sintering 31. In an embodiment of the present invention, brown part 26 was placed in a vacuum furnace in a vacuum atmosphere. In another embodiment, an inert atmosphere could also be used. Once the temperature in furnace 30 reached an intermediate temperature between about 816° C. (1500° F.) and about 1093° C. (2000° F.), brown part 26 was heated at the intermediate temperature for about 30 minutes, to help stabilize the niobium-containing carbides and maintain the small grain size of small particle 12. Any temperature in the range from about 816° C. (1500° F.) to about 1093° C. (2000° F.) may be selected for the intermediate temperature. In other embodiments of the method 300, the heating time for subjecting 310 brown part 26 to thermal cycling may vary from about 30 minutes to about 90 minutes to help remove or stabilize other undesirable phases from the microstructure of the stainless steel alloy composition 10 of the present invention.

Following thermal cycling, method 300 further comprises sintering 312 brown part 26 in furnace 30 at temperatures ranging from about 1246° C. (2250° F.) to about 1343° C. (2450° F.) for between about 60 minutes and about 180 minutes to make sintered part 32. Whether a certain temperature range may be preferred over another may depend on the amount of carbon desired in the resulting stainless steel ally composition 10 of net shape part 34. For example, where the desired carbon level in stainless steel alloy composition 10 is around 1.0 wt. %, the sintering temperature may be in a range of about 1246° C. (2275° F.) to about 1288° C. (2350° F.). On the other hand, where the desired carbon level is closer to 0.4 wt. %, then the sintering temperature may be in a range of about 1316° C. (2400° F.) to about 1343° C. (2450° F.). With desired carbon levels greater than about 0.4 wt. % but less than about 1.0 wt. %, the temperature may be in a middle range of greater than about 1288° C. (2350° F.) but less than about 1316° C. (2400° F.). In an embodiment of method 300, particularly where sintered part 32 is used without further processing, sintered part 32 may be cooled 311 in a cooling zone of furnace 30. For example, sintered part 32 may be used without further processing if the material densities required for the desired application may be achieved by sintering 312.

Although in one embodiment, the stainless steel alloy composition 10 in the form of brown part 26 was subjected 310 to thermal cycling and was sintered 312 in the vacuum furnace, in other embodiments of the method 300 other suitable batch or continuous furnaces (e.g., continuous furnace 30) could also be used, as would be familiar to one of ordinary skill in the art after becoming familiar with the teachings of the present invention. Thus, although FIG. 12 shows an embodiment of method 300 using continuous furnace 30 to illustrate the various types of heating and cooling steps of method 300, the method 100, 300 of the present invention should in no way be viewed as being limited in this respect.

Method 300 may further comprise performing 314 HIP'ing on sintered part 32, for example, when additional densification of the material is desired. Performing 314 HIP'ing may consolidate stainless steel alloy composition 10 to near full density, refine carbide structure and reduce pores, as well as carbide films that may have formed during sintering. In an embodiment of method 300 of the present invention, sintered part 32 was HIP'ed at a temperature of about 1066° C. (1950° F.) at a nominal pressure of about 103.42 megapascals (MPa) (15 kilopound per square inch (ksi)) for about four hours to a density of about 99% of theoretical density or greater. In another embodiment, sintered parts could be HIP'ed at a temperature from about 955° C. (1750° F.) to about 1232° C. (2250° F.) at a nominal pressure of about 68.95 MPa (10 ksi) to about 206.84 MPa (30 ksi) from about one to about four hours. Other HIP'ing parameters could also be used to achieve material density of about 99% of theoretical density or greater. In other embodiments, method 300 may not include HIP'ing where a desired density for the material can be achieved from sintering 312.

Following performing 314 HIP'ing, method 300 may comprise cooling 316 stainless steel alloy net shape part 34 at a rate of between about 1° C. (2° F.) per minute to about 11° C. (20° F.) per minute. Where maintaining the softness of stainless steel alloy net shape part 34 is desired, cooling 316 at a rate of between about 1° C. (2° F.) per minute and about 7° C. (12° F.) may be preferred. Where softness can be maintained by cooling at a rate of less than about 7° C. (12° F.), an annealing step may be avoided. However, in an embodiment where stainless steel alloy net shape part 34 has increased in hardness during cooling 316, method 300 may comprise an optional annealing step to soften stainless steel alloy net shape part 34 if further secondary machining is required.

Method 300 may further comprise additional heat treatment. Heat treatment may comprise austenitization and tempering. Thus, in one embodiment of the present invention, sintered part 32 may be hardened by austenitizing and subsequent quenching in the vacuum furnace with a gas quench. The material may then tempered to the desired hardness. In embodiments of method 300 of the present invention, austenitizing may be performed at between about 1010° C. (1850° F.) to about 1066° C. (1950° F.) with gas quenching occurring at about 0.2 MPa (0.029 ksi) to about 0.6 MPa (0.087 ksi). Tempering may be performed at about 204° C. (400° F.) to about 316° C. (600° F.). While these specific non-limiting examples have been provided, austenitizing, quenching and tempering may be conducted at other pressures and temperatures, or using other apparatus, as would be familiar to one of ordinary skill in the art after becoming familiar with the teachings of the present invention.

### Examples 1-26

Specific examples in which method 100 of the claimed invention was used to produce stainless steel alloy composition 10 will now be discussed. The method steps described above were used in each case. All of the examples were sintered 312; HIP'ing and/or subsequent heat treatment was employed as specifically noted. For each of the examples, the elemental composition of the metal powders used for feedstock 20 is described in Tables 1-26.

In Example 1, the supply of metal powders 16 weighed about 0.462 pounds of which 420 powder was about 80 wt. %; high carbon ferrochrome powder was about 10 wt. %; and unreduced CIP was about 10 wt. %. The binder 18 weighed 0.038 pounds or about 7.6 wt. % of the total feedstock 20 sample of about 0.500 pounds. Following sintering 312, the density of the stainless steel alloy composition 10 was about 7.53 g/cc. Carbon remaining was measured at about 1.17 wt. %. Small carbides 12 in the final stainless steel alloy composition 10 were very fine in size, but a few random large carbides 14 were observed. Elemental weight percents of the supply of metal powders 16 are shown in Table 1.

TABLE 1

| Element | Wt. % |
|---|---|
| Al | 0.006 |
| C | 1.348 |
| Cu | 0.000 |
| Cr | 16.886 |
| Fe | 75.971 |
| Mn | 0.248 |
| N | 0.071 |
| Nb | 2.248 |
| Ni | 0.000 |
| O | 0.267 |
| P | 0.018 |
| S | 0.010 |
| Si | 0.807 |

In Example 2, the supply of metal powder 16 weighed about 0.462 pounds of which 420 powder was about 47 wt. %; unreduced CIP was about 33 wt. %; ferrochrome powder (averaging particle size of less than 15 microns) was about 17 wt. %; and high carbon ferrochrome powder (over 90% of the particles of which were less than 10 microns in size) was about 3 wt. %. The binder 18 weighed 0.038 pounds or about 7.6 wt. % of the total feedstock 20 sample of about 0.500 pounds. Following sintering 312, the density of the stainless steel alloy composition 10 was about 7.25 g/cc. Carbon remaining was measured at about 0.368 wt. %. Elemental weight percents of the supply of metal powder 16 are shown in Table 2.

TABLE 2

| Element | Wt. % |
|---|---|
| Al | 0.002 |
| C | 0.794 |
| Cu | 0.000 |
| Cr | 12.790 |
| Fe | 83.153 |
| Mn | 0.066 |
| N | 0.286 |
| Nb | 1.175 |
| Ni | 0.376 |
| O | 0.636 |
| P | 0.022 |
| S | 0.019 |
| Si | 0.236 |

In Example 3, the supply of metal powders 16 weighed about 0.462 pounds of which 420 powder was about 51.50 wt. %; unreduced CIP was about 33.00 wt. %; ferrochrome powder (averaging particle size of less than 15 microns) was about 11.00 wt. %; and high carbon ferrochrome powder (over 90% of the particles of which were less than 10 microns in size) was about 4.50 wt. %. The binder 18 weighed 0.038 pounds or about 7.6 wt. % of the total feedstock 20 sample of about 0.500 pounds. Elemental weight percents of the supply of metal powders 16 are shown in Table 3.

TABLE 3

| Element | Wt. % |
|---|---|
| Al | 0.003 |
| C | 0.936 |
| Cu | 0.000 |
| Cr | 13.411 |
| Fe | 82.477 |
| Mn | 0.083 |
| N | 0.308 |
| Nb | 1.550 |
| Ni | 0.057 |
| O | 0.524 |
| P | 0.013 |
| S | 0.009 |
| Si | 0.624 |

In Example 4, the supply of metal powders 16 weighed about 0.464 pounds of which 420 powder was about 78.00 wt. %; ferrochrome powder (averaging particle size of less than 15 microns) was about 12.00 wt. %; unreduced CIP was about 5.00 wt. %; and high carbon ferrochrome powder (over 90% of the particles of which were less than 10 microns in size) was about 5.00 wt. %. The binder 18 weighed 0.036 pounds or about 7.2 wt. % of the total feedstock 20 sample of about 0.500 pounds. Following full sintering 312, the density of the stainless steel alloy composition 10 was about 7.10 g/cc. Carbon remaining was measured at about 0.582 wt. %. Elemental weight percents of the supply of metal powders 16 are shown in Table 4.

TABLE 4

| Element | Wt. % |
|---|---|
| Al | 0.004 |
| C | 0.914 |
| Cu | 0.000 |
| Cr | 16.315 |
| Fe | 79.283 |
| Mn | 0.088 |
| N | 0.113 |
| Nb | 1.950 |
| Ni | 0.624 |
| O | 0.539 |
| P | 0.034 |
| S | 0.025 |
| Si | 0.154 |

In Example 5, the supply of metal powders 16 weighed about 0.462 pounds of which 440C powder was about 40.00 wt. %; ferrochrome powder (averaging particle size of less than 15 microns) was about 20.00 wt. %; and unreduced CIP was about 40.00 wt. %. The binder 18 weighed 0.038 pounds or about 7.6 wt. % of the total feedstock 20 sample of about 0.500 pounds. Elemental weight percents of the supply of metal powders 16 are shown in Table 5.

TABLE 5

| Element | Wt. % |
|---|---|
| Al | 0.000 |
| C | 0.806 |
| Cu | 0.000 |
| Cr | 12.876 |
| Fe | 83.516 |
| Mn | 0.076 |
| N | 0.290 |
| Nb | 1.348 |
| Ni | 0.000 |
| O | 0.558 |
| P | 0.012 |
| S | 0.014 |
| Si | 0.600 |

In Example 6, the supply of metal powders 16 weighed about 0.462 pounds of which 420 powder was about 50.50 wt. %; ferrochrome powder (averaging particle size of less than 15 microns) was about 13.00 wt. %; unreduced CIP was about 33.00 wt. %; and high carbon ferrochrome powder (over 90% of the particles of which were less than 10 microns in size) was about 3.50 wt. %. The binder 18 weighed 0.038 pounds or about 7.6 wt. % of the total feedstock 20 sample tested of about 0.500 pounds. Elemental weight percents of the supply of metal powders 16 are shown in Table 6.

TABLE 6

| Element | Wt. % |
|---|---|
| Al | 0.002 |
| C | 0.850 |
| Cu | 0.000 |
| Cr | 13.178 |
| Fe | 82.820 |
| Mn | 0.085 |
| N | 0.312 |
| Nb | 1.520 |
| Ni | 0.056 |
| O | 0.533 |
| P | 0.013 |
| S | 0.009 |
| Si | 0.620 |

In Example 7, the supply of metal powders 16 weighed about 0.462 pounds of which 420 powder was about 53.00 wt. %; ferrochrome powder (averaging particle size of less than 15 microns) was about 6.00 wt. %; unreduced CIP was about 35.00 wt. %; and high carbon ferrochrome powder (over 90% of the particles of which were less than 10 microns in size) was about 6.0 wt. %. The binder 18 weighed 0.038 pounds or about 7.6 wt. % of the total feedstock 20 sample tested of about 0.500 pounds. Elemental weight percents of the supply of metal powders 16 are shown in Table 7.

TABLE 7

| Element | Wt. % |
|---|---|
| Al | 0.004 |
| C | 1.080 |
| Cu | 0.000 |
| Cr | 13.168 |
| Fe | 82.539 |
| Mn | 0.078 |
| N | 0.311 |
| Nb | 1.595 |
| Ni | 0.058 |
| O | 0.512 |
| P | 0.014 |
| S | 0.010 |
| Si | 0.629 |

In Example 8, the supply of metal powders 16 weighed about 0.462 pounds of which 420 powder was about 48.50 wt. %; ferrochrome powder (averaging particle size of less than 15 microns) was about 16.00 wt. %; unreduced CIP was about 33.00 wt. %; and high carbon ferrochrome powder (over 90% of the particles of which were less than 10 microns in size) was about 2.50 wt. %. The binder 18 weighed 0.038 pounds or about 7.6 wt. % of the total feedstock 20 sample tested of about 0.500 pounds. Elemental weight percents of the supply of metal powders 16 are shown in Table 7.

TABLE 8

| Element | Wt. % |
|---|---|
| Al | 0.002 |
| C | 0.757 |
| Cu | 0.000 |
| Cr | 13.105 |
| Fe | 83.040 |
| Mn | 0.087 |
| N | 0.318 |
| Nb | 1.460 |
| Ni | 0.053 |
| O | 0.544 |
| P | 0.013 |
| S | 0.009 |
| Si | 0.611 |

In Example 9, the supply of metal powders 16 weighed about 0.462 pounds of which 420 powder was about 52.00 wt. %; ferrochrome powder (averaging particle size of less than 15 microns) was about 4.00 wt. %; unreduced CIP was about 37.00 wt. %; and high carbon ferrochrome powder (over 90% of the particles of which were less than 10 microns in size) was about 7.00 wt. %. The binder 18 weighed 0.038 pounds or about 7.6 wt. % of the total feedstock 20 sample tested of about 0.500 pounds. Elemental weight percents of the supply of metal powders 16 are shown in Table 9.

TABLE 9

| Element | Wt. % |
|---|---|
| Al | 0.005 |
| C | 1.169 |
| Cu | 0.000 |
| Cr | 13.128 |
| Fe | 82.525 |
| Mn | 0.074 |
| N | 0.320 |
| Nb | 1.565 |
| Ni | 0.057 |
| O | 0.509 |
| P | 0.013 |
| S | 0.009 |
| Si | 0.624 |

In Example 10, the supply of metal powders 16 weighed about 10.219 pounds of which 420 powder was about 51.70 wt. %; ferrochrome powder (averaging particle size of less than 15 microns) was about 4.50 wt. %; unreduced CIP was about 37.00 wt. %; and high carbon ferrochrome powder (over 90% of the particles of which were less than 10 microns in size) was about 6.80 wt. %. The binder 18 weighed 0.781 pounds or about 7.1 wt. % of the total feedstock 20 sample tested of about 11.000 pounds. Following sintering 312, Example 10 was HIP'ed. Elemental weight percents of the supply of metal powders 16 are shown in Table 10.

TABLE 10

| Element | Wt. % |
|---|---|
| Al | 0.005 |
| C | 1.151 |
| Cu | 0.000 |
| Cr | 13.098 |
| Fe | 82.581 |
| Mn | 0.074 |
| N | 0.320 |
| Nb | 1.556 |
| Ni | 0.057 |
| O | 0.511 |
| P | 0.013 |
| S | 0.009 |
| Si | 0.622 |

In Example 11, the supply of metal powders 16 weighed about 10.219 pounds of which 420 powder was about 52.40 wt. %; ferrochrome powder (averaging particle size of less than 15 microns) was about 9.00 wt. %; unreduced CIP was about 34.00 wt. %; and high carbon ferrochrome powder (over 90% of the particles of which were less than 10 microns in size) was about 4.60 wt. %. The binder 18 weighed 0.781 pounds or about 7.1 wt. % of the total feedstock 20 sample tested of about 11.000 pounds. Following sintering 312, Example 11 was HIP'ed. Elemental weight percents of the supply of metal powders 16 are shown in Table 11.

TABLE 11

| Element | Wt. % |
|---|---|
| Al | 0.003 |
| C | 0.957 |
| Cu | 0.000 |
| Cr | 13.009 |
| Fe | 82.830 |
| Mn | 0.082 |
| N | 0.311 |
| Nb | 1.577 |
| Ni | 0.058 |
| O | 0.522 |
| P | 0.013 |
| S | 0.009 |
| Si | 0.627 |

In Example 12, the supply of metal powders 16 weighed about 10.219 pounds of which 420 powder was about 48.50 wt. %; ferrochrome powder (averaging particle size of less than 15 microns) was about 15.90 wt. %; unreduced CIP was about 33.00 wt. %; and high carbon ferrochrome powder (over 90% of the particles of which were less than 10 microns in size) was about 2.60 wt. %. The binder 18 weighed 0.781 pounds or about 7.1 wt. % of the total feedstock 20 sample tested of about 11.000 pounds. Following sintering 312, Example 12 was HIP'ed. Elemental weight percents of the supply of metal powders 16 are shown in Table 12.

TABLE 12

| Element | Wt. % |
|---|---|
| Al | 0.002 |
| C | 0.765 |
| Cu | 0.000 |
| Cr | 13.144 |
| Fe | 82.993 |
| Mn | 0.087 |
| N | 0.318 |
| Nb | 1.460 |
| Ni | 0.053 |
| O | 0.543 |
| P | 0.013 |
| S | 0.009 |
| Si | 0.611 |

In Example 13, the supply of metal powders 16 weighed about 10.153 pounds of which 420 powder was about 51.70 wt. %; ferrochrome powder (averaging particle size of less than 15 microns) was about 4.50 wt. %; unreduced CIP was about 37.00 wt. %; and high carbon ferrochrome powder (over 90% of the particles of which were less than 10 microns in size) was about 6.80 wt. %. The binder 18 weighed 0.847 pounds or about 7.7 wt. % of the total feedstock 20 sample tested of about 11.000 pounds. Following sintering 312 and HIP'ing, the density of the stainless steel alloy composition 10 was about 7.68 g/cc. Carbon remaining was measured at about 0.834 wt. %. Elemental weight percents of the supply of metal powders 16 are shown in Table 13.

TABLE 13

| Element | Wt. % |
|---|---|
| Al | 0.005 |
| C | 1.151 |
| Cu | 0.000 |
| Cr | 13.098 |
| Fe | 82.581 |
| Mn | 0.074 |
| N | 0.320 |
| Nb | 1.556 |
| Ni | 0.057 |
| O | 0.511 |
| P | 0.013 |
| S | 0.009 |
| Si | 0.622 |

In Example 14, the supply of metal powders 16 weighed about 10.153 pounds of which 420 powder was about 52.30 wt. %; ferrochrome powder (averaging particle size of less than 15 microns) was about 9.00 wt. %; unreduced CIP was about 34.00 wt. %; and high carbon ferrochrome powder (over 90% of the particles of which were less than 10 microns in size) was about 4.70 wt. %. The binder 18 weighed 0.847 pounds or about 7.7 wt. % of the total feedstock 20 sample tested of about 11.000 pounds. Following sintering 312, Example 14 was HIP'ed. Elemental weight percents of the supply of metal powders 16 are shown in Table 14.

TABLE 14

| Element | Wt. % |
|---|---|
| Al | 0.003 |
| C | 0.964 |
| Cu | 0.000 |
| Cr | 13.065 |
| Fe | 82.771 |
| Mn | 0.081 |
| N | 0.311 |
| Nb | 1.574 |
| Ni | 0.058 |
| O | 0.521 |
| P | 0.013 |
| S | 0.009 |
| Si | 0.626 |

In Example 15, the supply of metal powders 16 weighed about 10.153 pounds of which 420 powder was about 48.50 wt. %; ferrochrome powder (averaging particle size of less than 15 microns) was about 15.90 wt. %; unreduced CIP was about 33.00 wt. %; and high carbon ferrochrome powder (over 90% of the particles of which were less than 10 microns in size) was about 2.60 wt. %. The binder 18 weighed 0.847 pounds or about 7.7 wt. % of the total feedstock 20 sample tested of about 11.000 pounds. Following sintering 312, Example 15 was HIP'ed. Elemental weight percents of the supply of metal powders 16 are shown in Table 15.

TABLE 15

| Element | Wt. % |
|---|---|
| Al | 0.002 |
| C | 0.765 |
| Cu | 0.000 |
| Cr | 13.144 |
| Fe | 82.993 |
| Mn | 0.087 |
| N | 0.318 |
| Nb | 1.460 |
| Ni | 0.053 |
| O | 0.543 |
| P | 0.013 |
| S | 0.009 |
| Si | 0.611 |

In Example 16, the supply of metal powders 16 weighed about 10.186 pounds of which 420 powder was about 48.50 wt. %; ferrochrome powder (averaging particle size of less than 15 microns) was about 16.30 wt. %; unreduced CIP was about 33.00 wt. %; and high carbon ferrochrome powder (over 90% of the particles of which were less than 10 microns in size) was about 2.20 wt. %. The binder 18 weighed 0.814 pounds or about 7.4 wt. % of the total feedstock 20 sample tested of about 11.000 pounds. Following sintering 312 and HIP'ing, density of the final stainless steel alloy composition 10 was about 7.06 g/cc. The amount of carbon remaining was 0.746 wt. % of the metal powders. In the final product, carbides were of fine (e.g., small carbides 12) and medium size with good distribution through the ferrite matrix. Elemental weight percents of the supply of metal powders 16 are shown in Table 16.

TABLE 16

| Element | Wt. % |
|---|---|
| Al | 0.002 |
| C | 0.733 |
| Cu | 0.000 |
| Cr | 12.986 |
| Fe | 83.196 |
| Mn | 0.088 |
| N | 0.322 |
| Nb | 1.460 |
| Ni | 0.053 |
| O | 0.526 |
| P | 0.013 |
| S | 0.009 |
| Si | 0.611 |

In Example 17, the supply of metal powders 16 weighed about 0.463 pounds of which 420 powder was about 65.00 wt. %; ferrochrome powder (averaging particle size of less than 15 microns) was about 6.00 wt. %; unreduced CIP was about 22.500 wt. %; and high carbon ferrochrome powder (over 90% of the particles of which were less than 10 microns in size) was about 6.50 wt. %. The binder 18 weighed 0.037 pounds or about 7.4 wt. % of the total feedstock 20 sample tested of about 0.500 pounds. Following sintering 312, density of the final stainless steel alloy composition 10 was about 7.06 g/cc. The amount of carbon remaining was 0.746 wt. % of the metal powders. Elemental weight percents of the supply of metal powders 16 are shown in Table 17.

TABLE 17

| Element | Wt. % |
|---|---|
| Al | 0.005 |
| C | 1.101 |
| Cu | 0.000 |
| Cr | 15.153 |
| Fe | 80.199 |
| Mn | 0.094 |
| N | 0.236 |
| Nb | 1.957 |
| Ni | 0.072 |
| O | 0.463 |
| P | 0.016 |
| S | 0.011 |
| Si | 0.693 |

In Example 18, the supply of metal powders 16 weighed about 0.463 pounds of which 420 powder was about 65.00 wt. %; ferrochrome powder (averaging particle size of less than 15 microns) was about 17.00 wt. %; unreduced CIP was about 10.00 wt. %; and high carbon ferrochrome powder (over 90% of the particles of which were less than 10 microns in size) was about 8.00 wt. %. The binder 18 weighed 0.037 pounds or about 7.4 wt. % of the total feedstock 20 sample tested of about 0.500 pounds. Following sintering 312, density of the final stainless steel alloy composition 10 was about 7.37 g/cc. The amount of carbon remaining was 0.789 wt. % of the metal powders. Elemental weight percents of the supply of metal powders 16 are shown in Table 18.

TABLE 18

| Element | Wt. % |
|---|---|
| Al | 0.006 |
| C | 1.134 |
| Cu | 0.000 |
| Cr | 19.456 |
| Fe | 75.895 |
| Mn | 0.110 |
| N | 0.173 |
| Nb | 1.957 |
| Ni | 0.072 |
| O | 0.454 |
| P | 0.018 |
| S | 0.013 |
| Si | 0.712 |

In Example 19, the supply of metal powder weighed about 0.463 pounds of which 420 powder was about 50.00 wt. %; ferrochrome powder (averaging particle size of less than 15 microns) was about 10.00 wt. %; unreduced CIP was about 32.50 wt. %; and high carbon ferrochrome powder (over 90% of the particles of which were less than 10 microns in size) was about 7.50 wt. %. The binder 18 weighed 0.037 pounds or about 7.5 wt. % of the total feedstock sample tested of about 0.500 pounds. Following sintering 312, density of the final stainless steel alloy composition 10 was about 7.34 g/cc. The amount of carbon remaining was 0386 wt. % of the metal powders. In the stainless steel alloy composition 10, fine carbides (e.g., small carbides 12) were produced in a light network of carbides, as some sections were etched more heavily than others producing a dark appearance (e.g., dark area 15). Elemental weight percents of the supply of metal powders 16 are shown in Table 19.

TABLE 19

| Element | Wt. % |
|---|---|
| Al | 0.005 |
| C | 1.166 |
| Cu | 0.000 |
| Cr | 14.983 |
| Fe | 80.750 |
| Mn | 0.080 |
| N | 0.301 |
| Nb | 1.505 |
| Ni | 0.055 |
| O | 0.508 |
| P | 0.014 |
| S | 0.010 |
| Si | 0.623 |

In Example 20, the supply of metal powders 16 weighed about 0.463 pounds of which 420 powder was about 50.00 wt. %; ferrochrome powder (averaging particle size of less than 15 microns) was about 12.50 wt. %; unreduced CIP was about 32.50 wt. %; and high carbon ferrochrome powder (over 90% of the particles of which were less than 10 microns in size) was about 5.00 wt. %. The binder 18 weighed 0.037 pounds or about 7.5 wt. % of the total feedstock sample tested of about 0.500 pounds. Following sintering 312, density of the final stainless steel alloy composition 10 was about 7.17 g/cc. The amount of carbon remaining was 0.574 wt. % of the metal powders. In the stainless steel alloy composition 10, fine carbides (e.g., small carbides 12) were produced. Elemental weight percents of the supply of metal powders 16 are shown in Table 20.

TABLE 20

| Element | Wt. % |
|---|---|
| Al | 0.004 |
| C | 0.964 |
| Cu | 0.000 |
| Cr | 13.998 |
| Fe | 81.915 |
| Mn | 0.084 |
| N | 0.307 |
| Nb | 1.505 |
| Ni | 0.055 |
| O | 0.524 |
| P | 0.013 |
| S | 0.010 |
| Si | 0.620 |

In Example 21, the supply of metal powders 16 weighed about 10.19 pounds of which 420 powder was about 50.00 wt. %; ferrochrome powder (averaging particle size of less than 15 microns) was about 3.50 wt. %; unreduced CIP was about 37.50 wt. %; and high carbon ferrochrome powder (over 90% of the particles of which were less than 10 microns in size) was about 9.00 wt. %. The binder 18 weighed 0.81 pounds or about 7.32 wt. % of the total feedstock 20 sample tested of about 11.00 pounds. Following sintering 312, Example 21 was HIP'ed. Elemental weight percents of the supply of metal powders 16 are shown in Table 21.

TABLE 21

| Element | Wt. % |
|---|---|
| Al | 0.006 |
| C | 1.349 |
| Cu | 0.000 |
| Cr | 13.468 |
| Fe | 81.961 |
| Mn | 0.118 |
| N | 0.290 |
| Nb | 1.520 |
| Ni | 0.150 |
| O | 0.488 |
| P | 0.015 |
| S | 0.005 |
| Si | 0.630 |

In Example 22, the supply of metal powders 16 weighed about 0.926 pounds of which 420 powder was about 43.50 wt. %; ferrochrome powder (averaging particle size of less than 15 microns) was about 6.20 wt. %; unreduced CIP was about 37.50 wt. %; and high carbon ferrochrome powder (over 90% of the particles of which were less than 10 microns in size) was about 9.00 wt. %. The binder 18 weighed 0.0739 pounds or about 7.39 wt. % of the total feedstock sample tested of about 1.00 pounds. Following sintering 312, Example 22 was HIP'ed. Elemental weight percents of the supply of metal powders 16 are shown in Table 22.

TABLE 22

| Element | Wt. % |
|---|---|
| Al | 0.006 |
| C | 1.307 |
| Cu | 0.000 |
| Cr | 13.471 |
| Fe | 78.452 |
| Mn | 0.106 |
| N | 0.297 |
| Nb | 1.322 |
| Ni | 0.131 |
| O | 0.493 |
| P | 0.014 |
| S | 0.005 |
| Si | 0.587 |

In Example 23, the supply of metal powder 16 weighed about 19.86 pounds of which 420 powder was about 50.00 wt. %; unreduced CIP was about 44.50 wt. %; and high carbon ferrochrome powder (over 90% of the particles of which were less than 10 microns in size) was about 5.50 wt. %. The binder 18 weighed 1.442 pounds or about 6.77 wt. % of the total feedstock sample tested of about 21.30 pounds. The process included sintering 312 and HIP'ing. In addition, as explained in more detail below in reference to tensile strength testing, the stainless steel alloy composition 10 of the present example was subjected to austenitizing and tempering. Elemental weight percents of the supply of metal powders 16 are shown in Table 23.

TABLE 23

| Element | Wt. % |
|---|---|
| Al | 0.004 |
| C | 1.119 |
| Cu | 0.000 |
| Cr | 10.001 |
| Fe | 85.626 |
| Mn | 0.115 |
| N | 0.334 |
| Nb | 1.520 |
| Ni | 0.150 |
| O | 0.501 |
| P | 0.014 |
| S | 0.004 |
| Si | 0.814 |

In Example 24, the supply of metal powders 16 weighed about 0.462 pounds of which 440C powder was about 60.00 wt. %; ferrochrome powder (averaging particle size of less than 15 microns) was about 5.00 wt. %; unreduced CIP was about 30.00 wt. %; 17-4PH powder (averaging particle size of less than 15 microns) was about 3.00 wt. % and high carbon ferrochrome powder (over 90% of the particles of which were less than 10 microns in size) was about 2.00 wt. %. The binder 18 weighed 0.038 pounds or about 7.6 wt. % of the total feedstock 20 sample tested of about 0.500 pounds. Elemental weight percents of the supply of metal powders 16 are shown in Table 24.

TABLE 24

| Element | Wt. % |
|---|---|
| Al | 0.001 |
| C | 1.148 |
| Cu | 0.202 |
| Cr | 14.244 |
| Fe | 80.521 |
| Mn | 0.121 |
| N | 0.232 |
| Nb | 2.038 |
| Ni | 0.237 |
| O | 0.473 |
| P | 0.016 |
| S | 0.019 |
| Si | 0.749 |

In Example 25, the supply of metal powders 16 weighed about 0.464 pounds of which 420 powder was about 97.5 wt. % and high carbon ferrochrome powder (over 90% of the particles of which were less than 10 microns in size) was about 2.50 wt. %. The binder 18 weighed 0.036 pounds or about 7.2 wt. % of the total feedstock 20 sample tested of about 0.500 pounds. Following sintering 312, density of the final stainless steel alloy composition 10 was about 7.08 g/cc. The amount of carbon remaining was 0.643 wt. % of the metal powders. Elemental weight percents of the supply of metal powders 16 are shown in Table 25.

TABLE 25

| Element | Wt. % |
|---|---|
| Al | 0.002 |
| C | 0.857 |
| Cu | 0.000 |
| Cr | 13.847 |
| Fe | 80.562 |
| Mn | 0.224 |
| N | 0.000 |
| Nb | 2.964 |
| Ni | 0.293 |
| O | 0.361 |
| P | 0.026 |
| S | 0.006 |
| Si | 0.862 |

In Example 26, the supply of metal powders 16 weighed about 78.611 pounds of which 440C powder was about 45.50 wt. %; ferrochrome powder (averaging particle size of less than 15 microns) was about 6.00 wt. %; unreduced CIP was about 43.50 wt. %; and high carbon ferrochrome powder (over 90% of the particles of which were less than 10 microns in size) was about 5.00 wt. %. The binder 18 weighed 6.789 pounds or about 7.95 wt. % of the total feedstock 20 sample tested of about 85.40 pounds. Following sintering 312, Example 26 was HIP'ed. Elemental weight percents of the supply of metal powders 16 are shown in Table 26.

TABLE 26

| Element | Wt. % |
|---|---|
| Al | 0.004 |
| C | 1.310 |
| Cu | 0.000 |
| Cr | 13.247 |
| Fe | 82.284 |
| Mn | 0.092 |
| N | 0.341 |
| Nb | 1.533 |
| Ni | 0.000 |
| O | 0.532 |
| P | 0.013 |
| S | 0.013 |
| Si | 0.650 |

### Examples 27-29

In the remaining examples, mixtures of supply of metal powders 16 from previous examples were used to produce the stainless steel alloy composition 10 of the present invention.

Example 27 comprised a mixture of the feedstocks 20 of Example 10 and Example 13. Elemental weight percents were not available due to mixing of feedstocks 20. In Example 27, the feedstock 20 comprised 8.88 pounds of feedstock 20 from Example 10 (of which binder was 7.1 wt. %) and 3.12 pounds of feedstock 20 from Example 13 (of which binder was 7.7 wt. %). Feedstock 20 Example 27 was 12.000 pounds of which binder comprised 7.256 wt. %, or 0.871 pounds. The supply of metal powders 16 weighed about 11.129 pounds of which 420 powder was about 51.70 wt. %; ferrochrome powder (averaging particle size of less than 15 microns) was about 4.50 wt. %; unreduced CIP was about 37.00 wt. %; and high carbon ferrochrome powder (over 90% of the particles of which were less than 10 microns in size) was about 6.80 wt. %. Density of the final stainless steel alloy composition 10 was about 7.34 g/cc. The amount of carbon remaining was 0.83 wt. % of the metal powders.

Example 28 comprised a mixture of feedstock 20 from Examples 11 and 13. Elemental weight percents were not available due to mixing of feedstocks 20. The feedstock 20 in Example 28 comprised 6.84 pounds of feedstock 20 from Example 11 (of which binder was 7.1 wt. %) and 5.16 pounds of feedstock 20 from Example 13 (of which binder was 7.7 wt. %). Feedstock 20 for Example 28 was 12.000 pounds of which binder comprised 7.358 wt. %, or 0.8830 pounds. The supply of metal powder 16 weighed about 11.117 pounds of which 420 powder was about 52.40 wt. %; ferrochrome powder (averaging particle size of less than 15 microns) was about 9.00 wt. %; unreduced CIP was about 34.00 wt. %; and high carbon ferrochrome powder (over 90% of the particles of which were less than 10 microns in size) was about 4.60 wt. %. Density of the final stainless steel alloy composition 10 was about 6.99 g/cc. The amount of carbon remaining was 0.72 wt. % of the metal powders.

Example 29 comprised a mixture of feedstock 20 from Examples 12 and 15. Elemental weight percents were not available due to mixing of feedstocks 20. The feedstock 20 in the present example comprised 5.64 pounds of feedstock 20 from Example 12 (of which binder was 7.1 wt. %) and 6.36 pounds of feedstock from Example 15 (of which binder was 7.7 wt. %). Feedstock 20 for Example 29 was 12.000 pounds of which binder comprised 7.418 wt. %, or 0.8902 pounds. The supply of metal powder 16 weighed about 11.110 pounds of which 420 powder was about 48.50 wt. %; ferrochrome powder (averaging particle size of less than 15 microns) was about 15.90 wt. %; unreduced CIP was about 33.00 wt. %; and high carbon ferrochrome powder (over 90% of the particles of which were less than 10 microns in size) was about 2.60 wt. %. Density of the final stainless steel alloy composition 10 was about 6.92 g/cc. The amount of carbon remaining was 0.415 wt. % of the metal powders.

As mentioned above, tensile testing was performed on various embodiments of the stainless steel alloy composition 10. Tensile testing was performed at room temperature in accordance with ASTM A370-09a, with yield strength being determined by the 0.2% offset method. The results of tensile testing on six samples of stainless steel alloy composition 10 from Example 23 are set forth in Table 27. Samples 1-3 were subjected to heat treatment as were samples 4-6; however, tensile strength and yield strength were generally higher with samples 4-6.

TABLE 27

| | Tensile | Yield | | Reduction | Orig. Gate |
|---|---|---|---|---|---|
| | Strength | Strength | Elongation | of Area | Width |
| Sample¹ | (ksi) | (ksi) | in 1″ (%) | (%) | (in.) |
| 1 | 227.6 | 197.7 | 1.0 | <0.5 | 0.256 |
| 2 | 242.7 | 199.6 | 0.7 | <0.5 | 0.257 |
| 3 | 196.2 | 191.6 | 0.6 | <0.5 | 0.256 |
| 4 | 202.3 | N/A² | 0.2 | <0.5 | 0.256 |
| 5 | 250.4 | 231.7 | 0.6 | <0.5 | 0.257 |
| 6 | 252.9 | 231.0 | 0.7 | <0.5 | 0.256 |

¹Samples broke outside center, but within offset gage marks.
²Sample broke before yield.

Tensile testing was also performed on stainless steel alloy composition 10 from Examples 21, 22, 23, 26 and 30, all of which were annealed. Example 30 comprises a mixture of feedstocks 20 from Examples 23 and 26. Example 30 comprises 187.00 pounds of which 115.00 pounds (about 61.5%) was feedstock 20 from Example 23 and 72 pounds (about 38.5%) was feedstock 20 from Example 26, with binder percentages being within the ranges previously described in this specification. Results of tensile testing for Examples 21, 22, 23, 26 and 30 are shown in Table 28.

TABLE 28

| | Tensile | Yield | | Reduction | Orig. Gate |
|---|---|---|---|---|---|
| | Strength | Strength | Elongation | of Area | Width |
| Example | (ksi) | (ksi) | in 1″ (%) | (%) | (in.) |
| 21 | 100.0 | 44.2 | 10.0 | 12.0 | 0.252 |
| 22 | 105.4 | 47.5 | 17.5 | 29.0 | 0.251 |
| 23 | 95.8 | 41.2 | 23.0 | 41.0 | 0.252 |
| 26 | 96.5 | 40.4 | 23.0 | 41.0 | 0.250 |
| 30 | 96.9 | 42.6 | 25.0 | 44.0 | 0.251 |

In addition, wear testing was conducted on stainless steel alloy composition 10 from Example 23. Two samples (Sample 1 and Sample 2) from Example 23 were tested. Sample 1 and Sample 2 were subjected to two different heat treatments following sintering. Sample 1 was austenitized at about 1010° C. (1850° F.) with gas quenching at about 0.6 MPa (0.087 ksi) and tempering at about 204° C. (400° F.) temper. Sample 2 was austenitized at about 1066° C. (1950° F.) with gas quenching at about 0.2 MPa (0.029 ksi) tempering at about 316° C. (600° F.) temper.

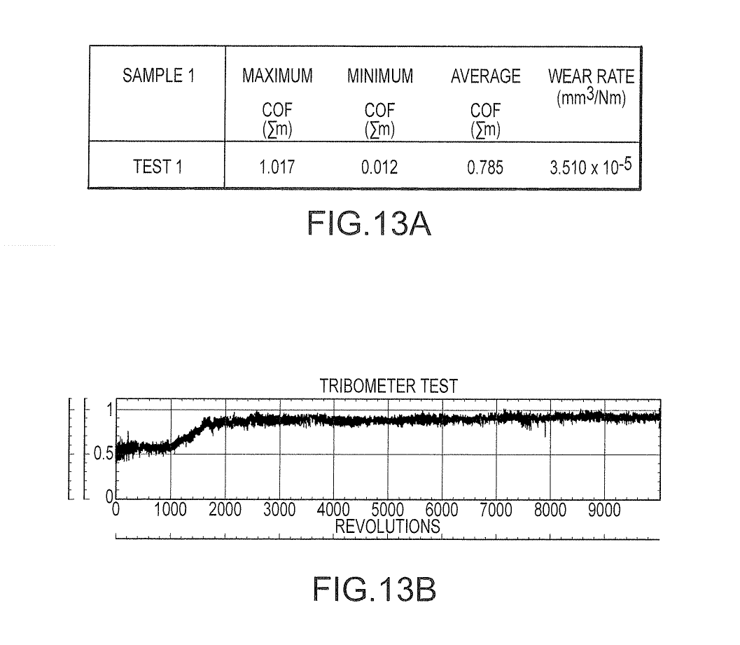

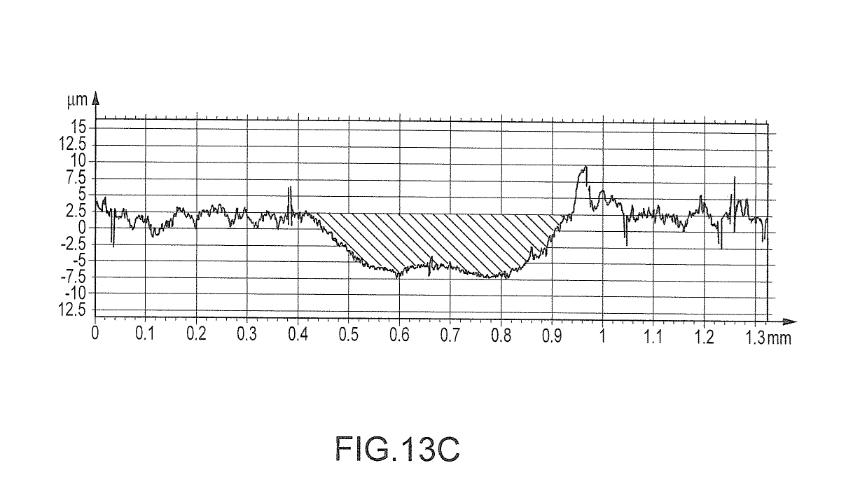

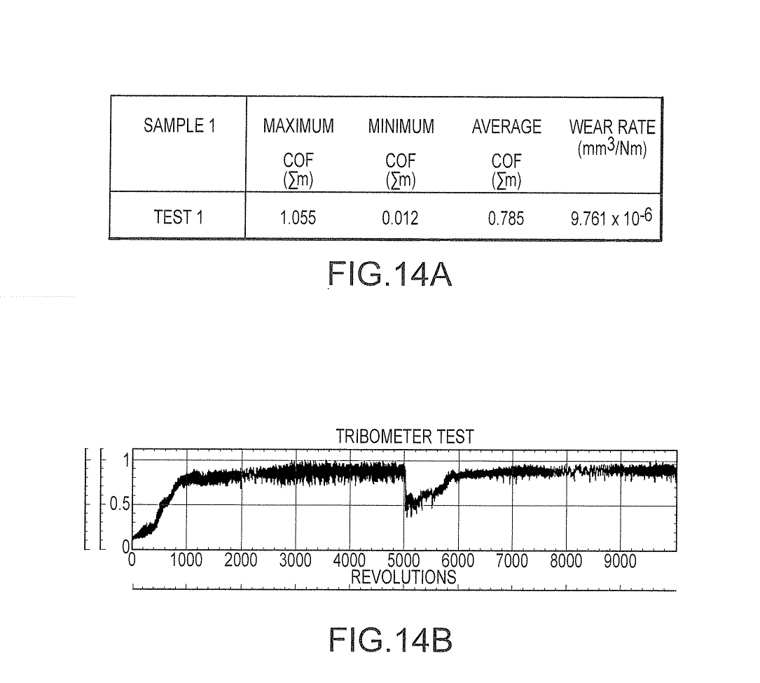

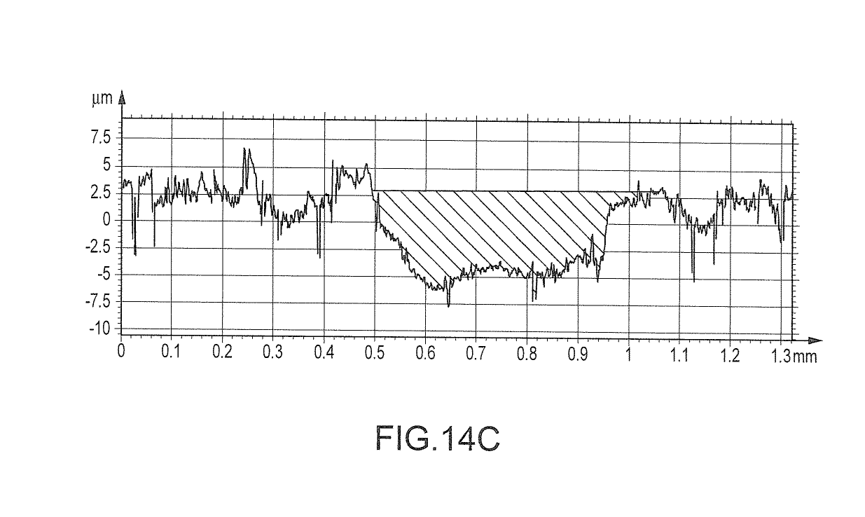

Wear testing was conducted using a pin-on-disk tribometer in accordance with ASTM G133. The load on each sample was 10.0 newtons (N) as applied for 20 hours as a speed rate of 500 rotations per minute for 10,000 revolutions. The radius of the track was 10 millimeters (mm). The ball, made of 440 stainless steel, was 3 mm in diameter. Tests were conducted in air at room temperature (23° C.) at 35% humidity. Results of the wear testing for Sample 1 are contained in FIG. 13. In FIG. 13(C), the area under the hole was measured as 3510 μm². Results of the wear testing for Sample 2 are contained in FIG. 14. In FIG. 14 (C), the area under the hole was measured as 3285 μm². While these results demonstrate higher wear resistance testing that for 420 stainless steel, wear resistance results were lower that those for T15 tool steel.

While the present invention only illustrates certain embodiments, it will be apparent to those skilled in the art after having read this disclosure that various changes and modifications can be made without departing from the claimed scope of the invention. For example, a skilled person in the art may change relative amounts, pressures on temperatures without departing from the scope of the present invention. Likewise, the terms of degree such as “substantially,” “about” and “approximate” as used herein mean a reasonable amount of deviation of the modified term such that the end result is not significantly changed. These terms can be construed as including a deviation of at least ±5% of the modified terra if this deviation would not negate the meaning of the word it modifies.

Having set forth the various embodiments, the present invention anticipates suitable modifications which remain within the scope of the invention. Therefore, a person skilled in the art should only construe this invention in accordance with the claims.

What is claimed is:

1. A stainless steel alloy composition, comprising:
rounded carbides in a matrix comprising at least one selected from the group consisting of ferrite and martensite, the rounded carbides having particle sizes under 5 microns, comprising a first quantity of niobium-containing carbide and a second quantity of chromium carbide, and being substantially free of large, irregularly-shaped carbides; and
free chromium in the matrix.

2. The stainless steel alloy composition of claim 1, wherein the first quantity exceeds the second quantity.

3. The stainless steel alloy composition of claim 1, wherein the niobium-containing carbide comprises Nb₄C₃.

4. The stainless steel alloy composition of claim 1, wherein the chromium carbide comprises Cr₂₃C₆.

5. The stainless steel alloy composition of claim 1, wherein the niobium-containing carbide is M₂₃C₆, wherein M comprises niobium and at least one other metal.

6. The stainless steel alloy composition of claim 1, wherein the first quantity and the second quantity combined comprise about 4 to about 25 wt. % of the stainless steel alloy composition.

7. A net shape part material, consisting of a densified alloy of precursor powders, the precursor powders having passed through a −325 U.S. Tyler mesh screen and comprising metal powders of at least carbon, chromium, niobium and iron, the carbon being in a first amount, the niobium being in a second amount that is greater than the first amount, and the chromium being in a third amount that is greater than the second amount.

8. The net shape part material of claim 7, wherein the third amount is between about 8.94 and about 17.85 times greater than the second amount.

9. The net shape part material of claim 8, wherein the third amount is between about 3.6 and about 16 times greater than the second amount.

10. The net shape part material of claim 9, wherein the precursor powders comprise supplemental powders, the supplemental powders comprising any of copper, silicon sulfur, and phosphorous.

11. The net shape part material of claim 7, the net shape part material being capable of being cold-worked.

12. A net shape part, comprising:
a solid, molded structure formed from an alloy, the alloy comprising:
rounded carbides in a matrix comprising at least one selected from the group consisting of ferrite and martensite, the rounded carbides having particle sizes under 5 microns, comprising a first quantity of niobium-containing carbide and a second quantity of chromium carbide, and being substantially free of large, irregularly-shaped carbides; and
free chromium in the matrix.

13. The net shape part of claim 12, wherein the solid, molded structure is capable of being cold-worked.

14. The net shape part of claim 12, wherein the solid, molded structure has a substantially smooth surface.

15. The net shape part of claim 12, wherein the first quantity is greater than the second quantity.

16. The net shape part of claim 15, wherein the first quantity and the second quantity combined are about 4 to about 25 wt. % of the alloy.

17. A method for making a stainless steel alloy net shape part, comprising:
providing a supply of metal powders comprising at least, carbon, niobium chromium and iron, the metal powders having an average particle size of less than about 25 microns;
removing oversized particles from the supply of metal powders to form a supply of sized metal powders consisting essentially of particles no greater than 44 microns in size with less than about 0.5 wt. % of the particles having a size between greater than about 44 microns and about 100 microns;
providing a supply of binder;
compounding the supply of sized metal powders with the supply of binder to form a feedstock;
injecting the feedstock into a near net shape mold, making a green part;
ejecting the green part from the near net shape mold;
debinding the green part, making a brown part;
subjecting the brown part to thermal cycling at a temperature between about 816° C. and about 1093° C.;
sintering the brown part in the furnace at a temperature between about 1246° C. and about 1343° C., making a sintered part;
performing hot isostatic pressing on the sintered part at a temperature between about 899° C. and about 1121° C., making the stainless steel alloy net shape part; and
cooling the stainless steel alloy net shape part at a rate of between about 1° C. per minute to about 7° C. per minute.

18. The method of claim 17, wherein the cooling comprises cooling the stainless steel alloy net shape part at a rate of between about 1° C. per minute to about 7° C. per minute and achieving at least about 99 percent of theoretical density without additional heat treatment.

19. The method of claim 18, wherein additional heat treatment comprises annealing, austenization or tempering.

20. The method of claim 18, further comprising cold working the stainless steel alloy net shape part.

21. The method of claim 17, wherein the performing hot isostatic pressing comprises performing hot isostatic pressing on the sintered part for about 4 hours.

22. The method of claim 17, wherein the performing hot isostatic pressing comprises performing hot isostatic pressing on the sintered part at a pressure of about 68.95 MPa to about 206.84 MPa.

23. The method of claim 17, further comprising heating the feedstock before the injecting.

24. The method of claim 17, wherein the compounding comprises forming the feedstock comprising from about 92 weight percent to about 93.5 weight percent metal powders and about 6.5 weight percent to about 8 weight percent binder, the weight percent of the metal powders and the weight percent of the binder totaling 100 wt. %.

25. The method of claim 17, wherein the removing comprising screening.

26. The method of claim 17, wherein the removing is performed immediately prior to the compounding.

27. The method of claim 17, further comprising admixing the metal powders in the supply of metal powders.

28. A feedstock for molded metal parts, comprising:
metal powders, the metal powders comprising at least carbon, niobium, chromium and iron, the metal powders consisting of particles no greater than −325 U.S. Tyler mesh in size and having an average particle size of less than about 25 microns; and
binder in combination with the metal powders to make the feedstock consisting of about 6.5 wt. % to about 8 wt. % binder and a remaining weight percent of the metal powders.

29. A method for making a feedstock for molded metal parts, comprising:
providing a supply of metal powders comprising at least, carbon, niobium, chromium and iron, the metal powders having an average particle size of less than about 25 microns;
passing particles from the supply of metal powders through a screen no larger than 325 U.S. Tyler mesh to form a supply of sized metal powders;
providing a supply of binder;
compounding the supply of sized metal powders with the supply of binder to form the feedstock, the feedstock consisting of binder in a range of between about 6.5 wt. % to about 8 wt. % and metal powders in a remaining wt. %.
